(19) United States
(12) Patent Application Publication
(10) Pub. No.: US 2006/0092290 A1
(43) Pub. Date: May 4, 2006

(54) Device and method for acquiring data from non-camera type acquisition device using a camera port

(76) Inventors: Dana C. Demeo, Lake Grove, NY (US); Thomas D. Bianculli, Manorville, NY (US); Alan J. Epshteyn, Dix Hills, NY (US); David T. Lundquist, Stony Brook, NY (US)

Correspondence Address: FAY KAPLUN & MARCIN, LLP, 15O BROADWAY, SUITE 702, NEW YORK, NY, 10038, US

(21) Appl. No.: 10/975,806

(22) Filed: Oct. 28, 2004

(51) Int. Cl. H04N 5/232; H04N 5/76; H04N 9/475

(52) U.S. Cl. 348/231.99; 348/211.3

(57) ABSTRACT

Described are a device and a method for acquiring data using a camera port of a processor. The device includes a processing unit; a memory arrangement storing a set of instructions; and a camera port. The camera port is configured to receive first data in a first format from a camera-type arrangement. The camera port receives from a non-camera type data acquisition device second data in a second format and the processing unit converts the second data into further second data stored in the first format using the set of the instructions.

### BACKGROUND INFORMATION

Computing devices have become an integral part of modern life, both as related to business activities and also for recreational purposes. In many cases, these devices combine multiple functions, such as computing, storing addresses, storing data, processing electronic mail and messages, and executing applications. Increasingly, more specialized functions are also carried out by these devices, such as scanning barcodes of products and merchandise. Such more specialized functions are useful to consumers, as well as to sellers and manufacturers to keep track of inventories, products, etc.

The computing devices typically comprise system-on-chip (SoC) computing architectures. The SoC architecture holds, on a chip, all necessary hardware and electronic circuitry for a complete system. The SoC includes an on-chip memory (RAM and ROM), a microprocessor, peripheral interfaces, I/O logic controls, data converters and other components that comprise a complete computer system. Typical internal and external peripherals include devices such as, a mouse, a printer, a monitor, a CD-ROM drive, a scanner, a camera, etc. To interact with these peripherals, the chip has an interface(s) that can communicate with each, such as a flash drive, a USB port, a camera port, etc.

These low-cost computing architectures, however, usually lack an interface capable of acquiring data from a specialized data acquisition device (e.g., undecoded scan engine). For example, the camera port can only receive data from the camera. This forces manufactures to supplement the computing architecture with an intelligent data acquisition device, such as an adapter or an application-specific integrated circuit (ASIC), which adds significant cost to the end-product. While most computing architectures have microprocessors that are capable of supporting the specialized data acquisition device, the microprocessors do not have an on-chip peripheral to acquire the data output from the specialized data acquisition device.

### SUMMARY OF THE INVENTION

The present invention relates to a device and a method for acquiring data using a camera port of a processor. The device includes a processing unit; a memory arrangement storing a set of instructions; and a camera port. The camera port is configured to receive first data in a first format from a camera-type arrangement. The camera port receives from a non-camera type data acquisition device second data in a second format and the processing unit converts the second data into further second data stored in the first format using the set of the instructions.

### BRIEF DESCRIPTION OF THE DRAWINGS

FIG. 1 shows an exemplary embodiment of an electronic device according to the present invention;

FIG. 2 shows an exemplary embodiment of a connection between a data acquisition device and a camera port according to the present invention;

FIG. 3 shows a further embodiment of a connection between the data acquisition device and the camera port of the present invention;

FIG. 4 shows a software task according to the present invention; and

FIG. 5 shows an exemplary embodiment of a method according to the present invention.

### DETAILED DESCRIPTION

The present invention may be further understood with reference to the following description and the appended drawings, wherein like elements are referred to with the same reference numerals. Modern developments in electronics have brought to the market a wide range of electronic devices that can perform many functions. These electronic devices combine multiple functions to provide the user with great flexibility in how to use them. For example, electronic computers have been incorporated with additional functionalities, such as the ability to connect without wires to a computer network. Access to the Internet, to local networks, to private networks and to a variety of other sources of data can be thus achieved without tying the device to data cables.

These devices have found extensive use as consumer electronics (e.g., for shopping assistance) and as work tools (e.g., for performing business functions). For example, a barcode scanner may be incorporated with a portable electronic processor, which provides the ability to manipulate data on the spot, and to connect with a remote database. One such barcode scanner is the MC 1000 terminal manufactured by Symbol Technologies, Inc. of Holtsville, N.Y. This terminal combines several electrical operative components such as a laser scanner capable of reading one and two dimensional barcode indicia with a data entry device (e.g., a keyboard) and an electronic processor, in a single device. The processor may be optimized to analyze the data read by the scanner, correlate it with existing databases, and/or control communication functions of the device.

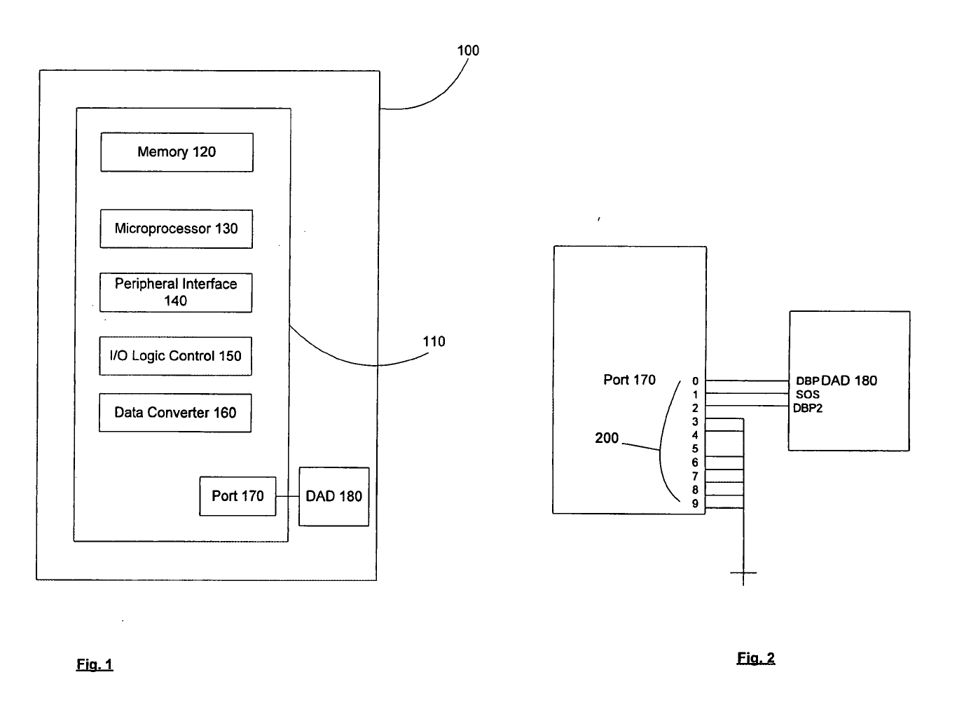

FIG. 1 shows an exemplary embodiment of an electronic device 100 with a processing unit according to the present invention. The device 100 may be an original equipment manufacturer (OEM) product such as, for example, a hand-held computer, a mobile phone, a PDA, a diagnostic device, a medical instrument, a component of an automated system, etc. The device 100 may operate with a system-on-chip (SoC) computing architecture, wherein a chip 110 holds all the necessary hardware and electronic circuitry to maintain the system of the device 100.

The chip 110 may contain a set of components similar to those utilized in typical devices. For example, the chip 110 may include an on-chip memory (RAM and ROM) 120 to store a set of instructions, a microprocessor 130, a peripheral interface 140, an I/O logic control 150, a data converter 160 and any other component that would complete the SoC. As would be understood by those skilled in the art, the chip 110 may include more than one peripheral interface 140, I/O logic control 150, and/or data converter 160. For example, further peripheral interfaces may include a flash drive interface, a USB interface, a serial port and/or a parallel port.

According to the present invention, the device 100 further includes a camera port 170 disposed on the chip 110. The port 170 may be internal, fully enclosed by the portable device 100, or external, having a portion exposed to the outer environment. As known by those skilled in the art, the camera port 170 is configured to receive first data only from a camera-type arrangement (e.g., a video camera, a photo camera, etc.). The first data may be camera-type data. As known by those skilled in the art, camera-type data typically has a format which consists of pixel information contained on a data bus, combined with a synchronization signal(s) to indicated a line boundary and a frame boundary. The synchronization signal is synchronized to a master pixel clock, and the pixel information indicates the color and intensity of the pixels. Accordingly, the present invention allows the camera port 170 to accept a signal from a data acquisition device (DAD) 180, which may be the camera-type arrangement or a non-camera type arrangement.

The port 170 is configured to receive both the first data from the camera-type arrangement, and second data from the non-camera type DAD 180. The second data is in a format that corresponds to the non-camera type DAD 180, which may not be the same format as the first data from the camera-type arrangement. The second data from the non-camera type DAD 180 may consist of, for example, data representing a real-time signal acquired from the non-camera type DAD 180. The synchronization signal typically found in camera-type data may not be present in the second data, and, thus, the second data may be asynchronous. As would be understood by those skilled in the art, the second data may be generated by photodetectors, magnetic head pickups, RF baseband signals, and strain gauges.

As seen in FIG. 1, the DAD 180 is connected to the port 170 within the device 100. In this embodiment, the DAD 180 may be, for example, an undecoded scan engine. As is understood by those skilled in the art, the undecoded scan engine is a scanning device that produces a digital video output representation of a barcode being scanned. However, as would be understood by those skilled in the art, the DAD 180 may connect to the port 170 through an external interface (not shown), which is disposed on an outer, environmentally-exposed surface of the DAD 180. As further understood by those skilled in the art, the DAD 180 may be a barcode reader, an RFID reader, a Magstripe reader or other specialized data acquisition device.

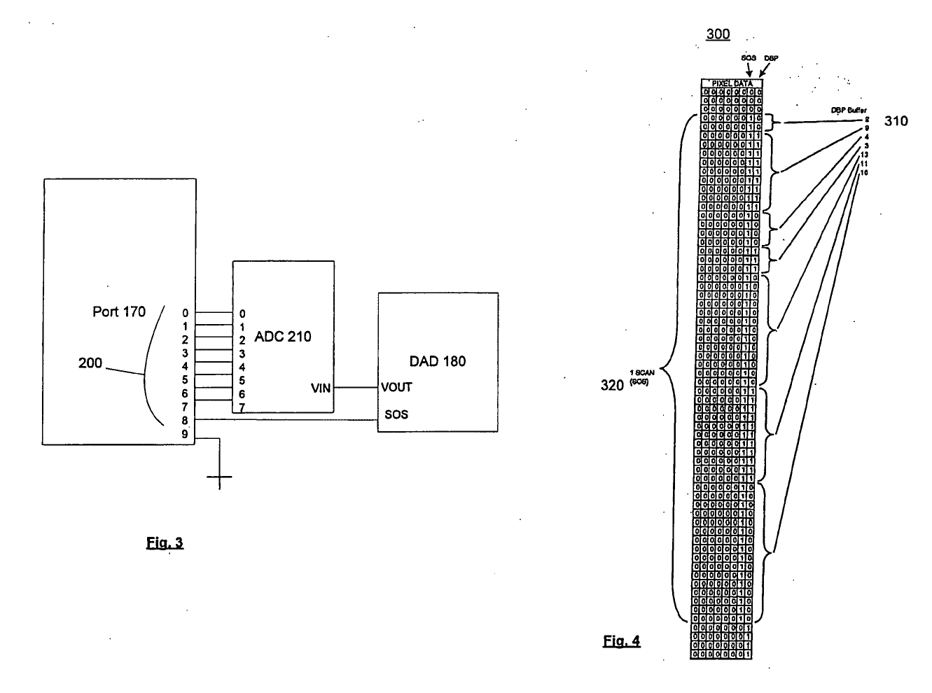

A more detailed view of the connection between the port 170 and the DAD 180 is seen in FIG. 2. The port 170 has a plurality of pins 200 for receiving one or more signals from the DAD 180. In the example of the DAD 180 being the undecoded scan engine, the signal may be a digitized bar pattern (DBP), which represents an image data of a barcode in a digitized form. The signal is sent to the port 170 via the pin 200. The undecoded scan engine may further send a start-of-scan (SOS) signal to the port 170. The undecoded scan engine may send yet a further signal, such as a second DBP, if the scan engine is equipped to run in a dual-DBP mode. As would be understood by those skilled in the art, the DAD 180 may connect directly to the port 170 if the DAD 180 has a digitized output.

The port 170 may be configured to run in a plurality of modes. For example, in a first exemplary embodiment, the port 170 may be configured to run in a non-gated mode, thereby allowing for a user-generated data acquisition timing. For instance, a set of controls (not shown) may be disposed on the device 100 which allows the user to operate the DAD 180.

In another exemplary embodiment, the port 170 may be configured to run in a slave mode. In this manner, configuration of the port 170 would cause the port 170 to map the signals from the DAD 180 as a digital image. As would be understood by those skilled in the art, configuring the port 170 to run in slave mode and acquire the digital image may be accomplished by setting a blanking interval as short as possible, while setting a pixel per line and a lines per frame as large as possible.

Preferably, the DBP signal(s) and the SOS signal are sampled at a high rate which increases the flexibility of the port 170 in interacting with a variety of DADs. The microprocessor 130 in the processing unit may convert the second data into further second data using the set of instructions in the memory 120, and store the further second data in the format of the first data. As understood by those skilled in the art, in slave mode, the high sample rate would make the blanking interval minimal. Also, in a preferred embodiment, the signals are transferred by direct memory access (DMA) such that the acquired data is sent to the on-chip memory 120 without passing it through the microprocessor 130. As would be understood in the art, using DMA may be advantageous if the acquired data is in a real-time format. However, if the acquired data is a still, photographic image, the acquired data may be sent to the on-chip memory 120 by DMA or through the microprocessor 130.

A further exemplary embodiment of the present invention is shown in FIG. 3. According to this embodiment, the DAD 180 outputs an analog signal to an analog-to-digital converter (ADC) 210. The ADC 210 converts the analog signal from the DAD 180 to a digitized signal, and transfers the digitized signal to the port 170. Preferably, the ADC 210 is an 8-bit ADC. In this manner, the analog signal can be sampled at a high rate using the port 170. Furthermore, use of the ADC 210 allows use of a wide range of DADs 180 (e.g., a barcode scanner, an RFID reader, a Magstripe reader) to transfer data to the port 170.

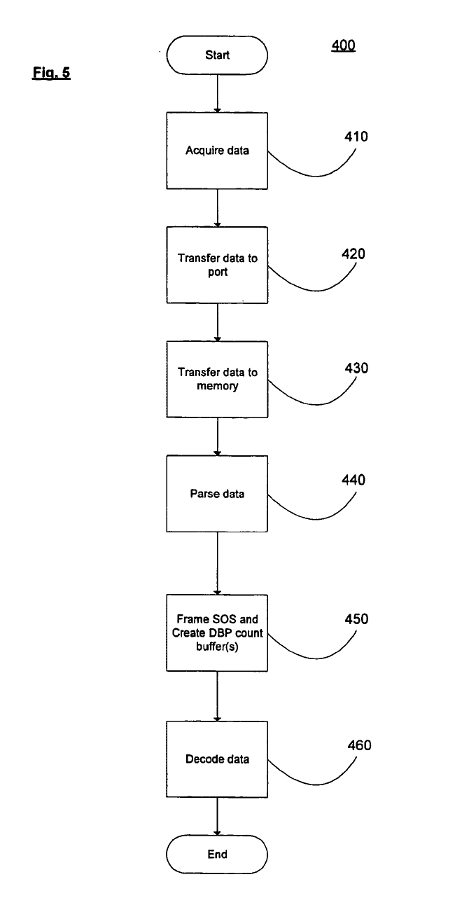

Along with the various hardware configurations discussed above, the present invention further includes a software application shown schematically at 300 in FIG. 4. In the embodiment involving the undecoded scan engine, the SOS signal and the DBP signal(s) are transferred to the on-chip memory 120, and more specifically, the RAM. Also, in this embodiment, a sample of data comprises 8 bits, thereby making the present scheme very flexible, in that the port 170 can acquire data from a wide variety of DADs. The software application 300 parses a raw form of the acquired data and creates a DBP count buffer 310 and an SOS frame 320. The parsed data is then sent to the microprocessor 130 to be decoded by a decoder algorithm. The decoder algorithm may be similar to those typically used and well-known in the art.

As is understood by those skilled in the art, each DAD 180 usable with the present invention may require a unique set of software to parse and decode/process the data. For example, some DADs 180 may use all data points (i.e., binary data in columns in FIG. 4) to decode the signal from the DAD 180, rather than forming the DBP count buffer 310. Other DADs 180 may form the DBP count buffer 310 using other criteria, and then decode/process the data using different algorithms. For example, when sampling the analog data with the ADC 210, a fuzzy logic decoding algorithm may act upon raw, analog sampled data directly. However, the SOS signal would still be sampled digitally to provide the SOS frame 320. Thus, the parsing would be to monitor the SOS signal to determine the SOS frame 320. Then, all the data from the DAD 180 is sent to the fuzzy logic algorithms.

FIG. 5 shows an exemplary method 400 of acquiring data according to the present invention. The present method will be described as if the DAD 180 is the undecoded scan engine, and the DAD 180 is disposed in an OEM device, such as a cellular phone or PDA. However, those skilled in the art would understand that the undecoded scan engine is simply an illustrative example of the DAD 180 that may be used with the present invention.

In step 410, the user acquires data (e.g., the DBP signal) by scanning of a barcode using, for example, an undecoded scan engine. As described above, the port 170 is configured to run in a non-gated mode, thus allowing the user to initiate scans at any time and for any length of time. In step 420, the acquired data created by the scan of the barcode is transferred to the port 170. As would be understood by those skilled in the art, if the DAD 180 outputs an analog signal, the analog signal may be converted to a digital signal by an ADC 210 before being transferred to the port 170.

In step 430, the acquired data is transferred from the port directly to the on-chip memory 120 (e.g., the RAM). As noted above, transfer of data without being passed through the microprocessor can be accomplished using DMA. While in the RAM, the software application 300 parses the acquired data, as indicated by step 440. Also, as indicated by step 450, while in the RAM, the software application 300 frames the SOS signal and creates the DBP count buffer(s). In step 460, the parsed data is decoded by the decoder algorithms in the microprocessor 130.

According to the invention herein described, the port 170 is configured to have a plurality of modes of operation, whereby any DAD 180 can communicate with the microprocessor 130 through the port 170. As would be understood by those skilled in the art, the method herein described would provide for fuzzy logic decoding within the microprocessor 130. Specifically, sampling the analog signal by the ADC 210 and the port 170 may facilitate fuzzy logic decoding. As further understood, the present invention is flexible enough to utilize advancements in scanning technologies, such as acquiring dual DBPs.

The present invention has been described with reference to embodiments that include a microprocessor, a port and a data acquisition device. Different types of data acquisition devices may be accommodated by embodiments of the present invention in addition to the undecoded scan engine described above. Accordingly, various modifications and changes may be made to the embodiments without departing from the broadest spirit and scope of the present invention as set forth in the claims that follow. In particular, other types of data acquisition devices may be used to interact with the port. The specification and drawings are accordingly to be regarded in an illustrative rather than in a restrictive sense.

What is claimed is:

1. A device, comprising:
a processing unit;
a memory arrangement storing a set of instructions; and
a camera port configured to receive first data in a first format from a camera-type arrangement;
wherein the camera port receives from a non-camera type data acquisition device second data in a second format, the processing unit converting the second data into further second data stored in the first format using the set of the instructions.

2. The device according to claim 1, further comprising:
an analog-to-digital converter processing data between the camera port and the data acquisition device.

3. The device according to claim 1, wherein the non-camera type data acquisition device is one of an undecoded scan engine, an RFID reader and a Magstripe reader.

4. The device according to claim 1, wherein the camera-type arrangement is one of a video camera and a photo camera.

5. The device according to claim 1, wherein the camera port is configured to run in a slave mode.

6. The device according to claim 1, wherein the camera port is configured to run in a non-gated mode.

7. The device according to claim 1, wherein the camera port transfers the second data to the memory arrangement via a direct memory access.

8. The device according to claim 1, wherein the second data is digitized bar pattern data.

9. The device according to claim 8, wherein the processing unit creates a digitized bar pattern count buffer and a start-of-scan frame to convert the second data into the further second data.

10. The device according to claim 2, wherein the processing unit converts the second data into further second data with a fuzzy logic algorithm.

11. The device according to claim 1, wherein the processing unit processes the further second data to generate third data which corresponds to the second data.

12. A method for acquiring data using a camera port of a processor, the camera port being configured to receive first data in a first format, comprising:
receiving second data from a non-camera type data acquisition device via the camera port, the second data being stored in a second format; and
converting the second data into further second data, the further second data being in a first data format.

13. The method according to claim 12, wherein the non-camera type data acquisition device is one of an undecoded scan engine, an RFID reader and a Magstripe reader.

14. The method according to claim 12, wherein the camera-type arrangement is one of a video camera and a photo camera.

15. The method according to claim 12, wherein the camera port is configured to run in a slave mode.

16. The method according to claim 12, wherein the camera port is configured to run in a non-gated mode.

17. The method according to claim 12, wherein the camera port transfers the second data to the memory arrangement via a direct memory access.

18. The method according to claim 12, wherein the second data is digitized bar pattern data.

19. The method according to claim 18, further comprising:
creating a digitized bar pattern count buffer and a start-of-scan frame to convert the second data into the further second data.

20. The method according to claim 12, further comprising:
converting the second data into further second data with a fuzzy logic algorithm.

21. The method according to claim 12, further comprising:
processing the further second data to generate third data which corresponds to the second data.
